(19) United States
(12) Patent Application Publication
(10) Pub. No.: US 2026/0355554 A1
(43) Pub. Date: Nov. 12, 2026

(54) ELECTROCHEMICAL SYSTEM FIRE EXTINGUISHING DEVICE AND HEAT PUMP SYSTEM USING COMPOSITION HAVING LOW GLOBAL WARMING POTENTIAL

(71) Applicant: Korea Institute of Energy Research, Daejeon (KR)

(72) Inventors: Jong Won CHOI, Daejeon (KR); Hak Geun JEONG, Daejeon (KR); Young Chan CHOI, Daejeon (KR); Gil Bong LEE, Daejeon (KR); Young Joo LEE, Sejong-si (KR)

(73) Assignee: Korea Institute of Energy Research, Daejeon (KR)

(21) Appl. No.: 19/121,758

(22) PCT Filed: Oct. 13, 2023
(86) PCT No.: PCT/KR2023/015834

§ 371 Date: Apr. 16, 2025

(30) Foreign Application Priority Data
Oct. 17, 2022 (KR) 10-2022-0133463
Oct. 20, 2022 (KR) 10-2022-0135868

(51) Int. Cl. A62C 31/02; A62C 3/16; F25B 30/02; F25B 41/31

(52) U.S. Cl. CPC A62C 31/02; A62C 3/16; F25B 30/02; F25B 41/31

(57) ABSTRACT

The present invention relates to an electrochemical system fire extinguishing device and a heat pump system using a composition having a low global warming potential (GWP) and, more specifically, to a fire extinguishing device and a heat pump system, comprising cooling and extinguishing functions of an electrical or chemical heat-generating device using an insulating refrigerant having low environmental impact, wherein the fire extinguishing device cools the electrical or chemical heat-generating device, which is in a normal state, by using a refrigerant of a cooling device, when a fire occurs in the electrical or chemical heat-generating device, senses the occurrence of the fire, extinguishes the fire by means of direct contact jetting onto the electrical or chemical heat-generating device, and uses an insulating refrigerant to be vaporized which has a GWP of 1 or less.

### TECHNICAL FIELD

The present disclosure relates to a composition having a low global warming potential and a device and a system for extinguishing fire in a battery using the composition.

### BACKGROUND ART

As prices of energy sources increase due to the exhaustion of fossil fuels and interest in environmental pollution grows recently, the demand for environmentally friendly alternative energy sources has become essential for the future. For this reason, research on various electric power generation technologies, such as nuclear power, solar energy, wind power, tidal power, or the like is ongoing, and there is great interest in power storage apparatuses for efficiently using energy generated by such technologies.

In particular, as the technological development of energy storage systems (ESS), which are for storing energy, and the demand for them increase, the demand for batteries as an energy source is sharply increasing. Accordingly, lots of research works on batteries that can meet various requirements are being conducted.

Representatively, in terms of the shape of batteries, the demand for prismatic secondary batteries and pouch secondary batteries is high because their thin design allows them to be used in products such as cellular phones, and in terms of their material, the demand for lithium secondary batteries, such as lithium-ion batteries and lithium-ion polymer batteries, is high because they have advantages such as high energy density, high discharge voltage, and high output stability.

Additionally, secondary batteries may be classified based on the structure of electrode assemblies, in which an anode, a cathode, and a separator interposed between the anode and the cathode are stacked. Examples may include a jelly-roll type (wound type) electrode assembly having a structure in which long-sheet-shaped anodes and cathodes are wound with separators interposed between them and a stack type (laminated type) electrode assembly having a structure in which multiple anodes and cathodes, cut into units of a predetermined size, are sequentially stacked with separators interposed between them. Recently, an electrode assembly with an advanced structure was developed in order to resolve problems of the jelly-roll type electrode assembly and the stack type electrode assembly. The newly developed electrode assembly has a structure in which the jelly-roll type electrode assembly and the stack type electrode assembly are mixed. This is a stack/folded type electrode assembly, in which anodes and cathodes, each in a predetermined unit, are stacked with separators interposed between them to form a unit cell, each unit cell is placed on a separating film, and unit cells on separating films are then sequentially wound.

Secondary batteries may also be classified based on battery case shapes into cylindrical batteries or prismatic batteries, in which electrode assemblies are housed in cylindrical or prismatic metal cans, and pouch batteries, in which electrode assemblies are housed in pouch cases made of aluminum-laminated sheets.

Such secondary batteries may be exposed to various environments depending on the states and conditions of use, and the risk of explosion needs to be particularly prevented for the safety of users.

Specifically, the high temperature or high pressure inside a secondary battery, which may result from abnormal usage conditions, such as an internal short circuit, charging with a current or voltage level exceeding an allowable level, exposure to high temperature, or shock due to a fall, may cause the secondary battery to explode.

Considering the above matter, it would be essential to maintain an appropriate battery temperature and to prevent further damage by rapid suppression of battery fires.

For this reason, regardless of morphological differences as described above, each secondary battery comprises a high-pressure relieving means to relieve the high pressure, which is a direct cause of battery explosion.

Korean patent publication No. 10-2416007 discloses a battery fire-extinguishing system using an environmentally friendly fire-extinguishing liquid comprising: a battery case having battery spaces in which a plurality of battery cells are accommodated, respectively; a fire-extinguishing injection unit installed in the battery case to detect fires in the battery cells and to inject a fire-extinguishing liquid; a fire-extinguishing liquid supply unit supplying a fire-extinguishing liquid to the fire-extinguishing injection unit; and an injection controller controlling the fire-extinguishing injection unit by detecting abnormalities in the battery cells. The injection controller includes two or more of a temperature detection sensor detecting the temperatures of the battery cells, a smoke detection sensor detecting smoke generated in the battery cells, and a pressure detection sensor detecting the pressures of the battery cells, and determines whether a fire occurs based on information detected by the two or more sensors such that the fire-extinguishing liquid is injected into the battery cells through the fire-extinguishing injection unit. The fire-extinguishing injection unit includes a movable member having a plurality of short-circuit injection nozzles, which moves toward the position where the battery cells are located when the injection controller detects a fire, and forms a plurality of short-circuit points penetrating the battery cells so as to quickly discharge the battery cells and inject the fire-extinguishing liquid into the penetrated interior of the battery cells. In this publication, the fire-extinguishing liquid includes a foaming agent that generates bubbles in a solvent containing water from which chlorine ions are removed, a foam stabilizer that stabilizes the bubbles, a foam aid that prevents the bubbles from easily disappearing, and a pour point depressant that lowers the freezing temperature of the fire-extinguishing mixture. However, this publication does not disclose a battery pack fire-extinguishing system using an insulating refrigerant having a low environmental impact serving as a refrigerant for cooling the battery pack in a normal state and as a fire-extinguishing liquid for extinguishing fire by being injected to come into direct contact with the battery cells in an abnormal state, such as fire in the battery cells.

Korean patent publication No. 10-2304158 discloses a technology of maintaining a battery cell at an optimum temperature by providing a battery cooling system comprising a battery module including a plurality of battery cells and connected to an external power load; and a refrigerant inducing unit mounted on the battery module and configured to allow a refrigerant supplied from an external air-conditioner to pass into the battery module so as to allow the refrigerant to cool the battery module. However, the refrigerant is for cooling battery cells, and this publication does not disclose a battery pack fire-extinguishing system using an insulating refrigerant having a low environmental impact serving as a fire-extinguishing liquid for extinguishing a fire by being injected to come into direct contact with the battery cells in an abnormal state such as a fire in the battery cells.

Korean patent publication No. 10-1066021 discloses a secondary battery in which microcapsules, each containing a material for ensuring safety (‘safety-guaranteeing material’), are applied to a portion that does not directly affect the operation of the battery, wherein the portion is where a short circuit can easily occur due to the heat buildup and internal/external pressures when any abnormality, such as a static abnormality or a physical impact, occurs. However, it is challenging for this technology to include microcapsules, which serve as a material for ensuring safety in further fire-extinguishing, in battery cells so as to reduce the energy density of a battery pack containing the battery cells and to control fire-extinguishing in an abnormal state, such as a fire. In addition, this publication does not disclose a battery pack fire-extinguishing system using an insulating refrigerant having a low environmental impact serving as a refrigerant for cooling the battery pack in a normal state and as a fire-extinguishing liquid for extinguishing a fire by being injected to come into direct contact with the battery cells in an abnormal state, such as a fire in the battery cells.

Korea patent laid-open gazette No. 10-2018-0047439 discloses a battery pack comprising: an electrode assembly having an anode, a cathode, and a separator interposed therebetween; a first pack case with the electrode assembly and an electrolyte disposed therein, the first pack case having a first open end defining a first opening; a second pack case with the first pack case disposed therein and a portion of the interior surface separated from the first pack case exterior surface; a fire extinguishing agent disposed between the exterior surface of the first pack case and the interior surface of the second pack case; a cap assembly coupled to the first and second pack cases to simultaneously seal an opening of the first pack case and an opening of the second pack case, wherein the first pack case, in which the electrode assembly and the electrolyte are accommodated, and the fire extinguishing agent are together accommodated in the second pack case; and a first venting portion formed on the exterior surface of the first pack case, wherein the first venting portion is configured to open to enable the fire extinguishing agent, disposed throughout the cavity between the exterior surface of the first pack case and the interior surface of the second pack case, to flow into the interior of the first pack case when a pressure within the first pack case is greater than or equal to a critical pressure. However, this publication does not disclose a battery pack fire-extinguishing system using an insulating refrigerant having a low environmental impact, which serves as a refrigerant for cooling the battery pack in a normal state and as a fire-extinguishing liquid for extinguishing a fire by being injected to come into direct contact with the battery cells in an abnormal state, such as a fire in the battery cells.

Accordingly, a device and a system having cooling and fire-extinguishing functions for addressing electrical or chemical heat generation in a device using an insulating refrigerant with a low environmental impact, with a global warming potential (GWP) of 1 or lower, are required to be developed, wherein the insulating refrigerant serves as a refrigerant for a refrigerating device to cool a battery pack when the battery pack is in a normal state and, when a fire occurs in battery cells included in the battery pack and it is sensed, the insulating refrigerant is injected to come into direct contact with the battery cells to extinguish the fire.

### DETAILED DESCRIPTION OF THE INVENTION

### Technical Problem

An aspect of the present disclosure is to provide a fire-extinguishing device for a battery configured to detect fire occurring in the battery and to directly inject a composition or refrigerant into the battery so that the composition or refrigerant can extinguish the fire and evaporate.

Another aspect of the present disclosure is to provide a battery fire-extinguishing device using a composition or refrigerant that cools a battery when the battery is in a normal state and extinguishes fire when it occurs in the battery by being directly delivered to the battery.

Further, another aspect of the present disclosure is to provide a device and a system having cooling and fire-extinguishing functions for an electrical or chemical heat-generating device using an insulating composition or refrigerant with a low environmental impact of a global warming potential (GWP) of 1 or lower, that serves as a refrigerant for a cooling device to cool the electrical or chemical heat-generating device when the device is in a normal state and extinguishes fire by being directly delivered to the electrical or chemical heat-generating device when the fire occurs and is detected in the electrical or chemical heat-generating device.

### Technical Solution

In a fire-extinguishing device for an electrochemical system and a heat pump system according to an embodiment, which use a composition with a low global warming potential (GWP), the composition with a low GWP may include a refrigerant, and specifically, a refrigerant with a low GWP.

To achieve the aforementioned aspect, an embodiment of the present disclosure provides a fire-extinguishing device for an electrochemical system using a refrigerant, comprising: a supplying unit configured to supply the refrigerant to be in direct contact with the electrochemical system; and a storage unit configured to store the refrigerant.

In the fire-extinguishing device for an electrochemical system according to the present disclosure, the supplying unit may comprise an injecting device configured to inject the refrigerant into the electrochemical system when a fire occurs in the electrochemical system.

In the fire-extinguishing device for an electrochemical system according to the present disclosure, the injecting device may comprise a nozzle through which the refrigerant is injected.

In the fire-extinguishing device for an electrochemical system according to the present disclosure, an injection hole of the nozzle may be sealed with a thermo-sensitive tube.

In the fire-extinguishing device for an electrochemical system according to the present disclosure, the storage unit may have a pressure higher than the atmospheric pressure.

In the fire-extinguishing device for an electrochemical system according to the present disclosure, the supplying unit may comprise a refrigerant tube through which the refrigerant is supplied from the storage unit to discharge the refrigerant into the electrochemical system when a fire occurs in the electrochemical system, thereby extinguishing the fire.

In the fire-extinguishing device for an electrochemical system according to the present disclosure, the refrigerant tube may be disposed in contact with the electrochemical system and perform heat management of the electrochemical system through heat exchange with the electrochemical system.

In the fire-extinguishing device for an electrochemical system according to the present disclosure, the refrigerant tube may rupture or melt when a fire occurs in the electrochemical system.

In the fire-extinguishing device for an electrochemical system according to the present disclosure, the refrigerant tube may be composed of a thermally conductive material and a thermo-sensitive tube, wherein the thermo-sensitive tube may rupture or melt when a fire occurs in the electrochemical system.

In the fire-extinguishing device for an electrochemical system according to the present disclosure, the electrochemical system may be one of a battery, a battery cell, a battery module, a battery pack, a battery rack, a hybrid vehicle, an electric vehicle, an energy storage system (ESS), or a distribution board.

In the fire-extinguishing device for an electrochemical system according to the present disclosure, the refrigerant may contain at least one of methane-based halogenated carbon compounds of refrigerant Nos. 10 to 59, ethane-based halogenated carbon compounds of refrigerant Nos. 110 to 179, propane-based halogenated carbon compounds of refrigerant Nos. 200 to 299, cyclic butane-based halogenated carbon compounds of refrigerant Nos. 300 to 399, non-azeotropic mixed refrigerants of refrigerant Nos. 400 to 499, azeotropic mixed refrigerants of refrigerant Nos. 500 to 599, hydrocarbons, oxygen compounds, sulfur compounds, and nitrogen compounds of refrigerant Nos. 600 to 699, inorganic compounds of refrigerant Nos. 700 to 799, or unsaturated organic compounds of refrigerant Nos. 1000 to 1999 based on the American Society of Heating, Refrigerating and Air-Conditioning Engineers (ASHRAE) Standard 34.

In the fire-extinguishing device for an electrochemical system according to the present disclosure, the refrigerant may include at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A; hydrofluorocarbon refrigerants (HFCs), including R-407A, R-407F, R-410A, R-422D, R-134a, R-507A, R-245fa, R-407C, R-408A, R-404A, R-508B, or R-23;hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

In the fire-extinguishing device for an electrochemical system according to the present disclosure, the refrigerant may have a saturated evaporation temperature of −10 °C or higher and 60 °C or lower at atmospheric pressure, an electrical conductivity of 0 S/cm, a global warming potential (GWP) of 0 or greater and 2 or less, and an ozone depletion potential (ODP) of 0 or greater and 0.001 or less, and it does not fall within a flammable range.

In the fire-extinguishing device for an electrochemical system according to the present disclosure, the refrigerant may include nanoparticles in an amount greater than 0 weight % and up to 5 weight % containing at least one of Au, Ag, Cu, Al, CuO, Co, Fe, TiO2, CNT, GO, or fullerene.

In the fire-extinguishing device for an electrochemical system according to the present disclosure, the refrigerant may contain a surfactant in an amount of greater than 0 weight % and up to 5 weight % including at least one of CTAB and Span-80.

To achieve the aforementioned aspect, an embodiment of the present disclosure provides a heat pump system comprising: a flash tank configured to store a refrigerant in a gaseous or liquid state; a compressor configured to compress the refrigerant so that it has high temperature and high pressure; a first heat exchanger configured to exchange heat between the refrigerant and an external environment and to function as either an evaporator for heat absorption or a condenser for heat dissipation; a second heat exchanger configured to perform functions opposite to those of the first heat exchanger and to function as either an evaporator or a condenser; a first expansion valve connected to the flash tank and configured to supply a low-temperature and low-pressure refrigerant; a second expansion valve connected to the flash tank and configured to receive the refrigerant in a liquid state from the flash tank and to bring the refrigerant to a low temperature and a low pressure; a first four-way valve configured to selectively connect the flash tank, first heat exchanger, second heat exchanger, and first expansion valve to one another; a second four-way valve configured to selectively connect the compressor, first heat exchanger, and second heat exchanger to one another; a first valve connected in parallel with the first expansion valve; a second valve connected in parallel with the second expansion valve; a third valve disposed between the flash tank and the compressor; and a fourth valve disposed between the flash tank and the second heat exchanger.

In the heat pump system according to the present disclosure, the flash tank may comprise a device that generates heat through electrical or chemical reactions, the device may exchange heat with a refrigerant stored in the flash tank, and, when a fire occurs in the device, the refrigerant stored in the flash tank may extinguish the fire.

In the heat pump system according to the present disclosure, the device may be any one of a battery cell, a battery module, a battery pack, a battery rack, a hybrid vehicle, an electric vehicle, an energy storage system (ESS), or a distribution board.

According to the present disclosure, the heat pump system may operate in any one of a cooling mode, a heating mode, or an intermediate mode.

According to the present disclosure, when the heat pump system operates in a cooling mode, the refrigerant in a gaseous state in the flash tank may sequentially circulate through the third valve, the compressor, the second four-way valve, the second heat exchanger, which serves as a condenser, then through the first four-way valve, and the first expansion valve, and may be supplied back to the flash tank as a low-temperature and low-pressure refrigerant. The refrigerant in a liquid state in the flash tank may sequentially circulate through the second valve, the first four-way valve, the first heat exchanger, which serves as an evaporator, then through the second four-way valve, the compressor, the second heat exchanger, which serves as a condenser, then through the first four-way valve, and the first expansion valve, and may be supplied back to the flash tank as a low-temperature and low-pressure refrigerant.

According to the present disclosure, when the heat pump system operates in a heating mode, the refrigerant in a liquid state in the flash tank may sequentially circulate through the second expansion valve, the first four-way valve, the second heat exchanger, which serves as an evaporator, then through the second four-way valve, the compressor, the first heat exchanger, which serves as a condenser, the first four-way valve, and the first valve, and may be supplied to the flash tank as a liquid refrigerant.

According to the present disclosure, when the heat pump system operates in an intermediate mode, the refrigerant in a gaseous state in the flash tank may sequentially circulate through the third valve, the second four-way valve, and the second heat exchanger, and may be supplied back to the flash tank.

The heat pump system according to the present disclosure may comprise a pump and a check valve for supplying the refrigerant that has passed through the second heat exchanger to the flash tank.

In the heat pump system according to the present disclosure, the refrigerant may contain at least one of methane-based halogenated carbon compounds with refrigerant numbers in the 10 to 50 range, ethane-based halogenated carbon compounds with refrigerant numbers in the 110 to 170 range, propane-based halogenated carbon compounds with refrigerant numbers in the 200 to 290 range, cyclic butane-based halogenated carbon compounds with refrigerant numbers in the C300 range, non-azeotropic mixed refrigerants with refrigerant number in the 400 range, azeotropic mixed refrigerants with refrigerant numbers in the 500 range, hydrocarbons, oxygen compounds, sulfur compounds, and nitrogen compounds with refrigerant number in the 600 range, inorganic compounds with refrigerant number in the 700 range, or unsaturated organic compounds with refrigerant numbers in the 1000 range, based on the American Society of Heating, Refrigerating and Air-Conditioning Engineers (ASHRAE) Standard 34.

In the heat pump system according to the present disclosure, the refrigerant may include at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A; hydrofluorocarbon refrigerants (HFCs), including R-407A, R-407F, R-410A, R-422D, R-134a, R-507A, R-245fa, R-407C, R-408A, R-404A, R-508B, or R-23; hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

In the heat pump system according to the present disclosure, the refrigerant may have a saturated evaporation temperature of −10 °C or higher and 60 °C or lower at atmospheric pressure, an electrical conductivity of 0 S/cm, a global warming potential (GWP) of 0 or greater and 2 or less, and an ozone depletion potential (ODP) of 0 or greater and 0.001 or less, and it does not fall within a flammable range.

In the heat pump system according to the present disclosure, the refrigerant may include at least one of nanoparticles in an amount greater than 0 weight % and up to 5 weight %, containing at least one of Au, Ag, Cu, Al, CuO, Co, Fe, TiO2, CNT, GO, or fullerene; a surfactant in an amount of greater than 0 weight % and up to 5 weight %, including at least one of CTAB and Span-80; or an insulating oil to improve the insulating properties.

Another embodiment of the present disclosure provides a battery fire-extinguishing system comprising: a battery module including one or more battery cells; a cooling device including a refrigerant performing heat exchange with the battery module; and a fire-extinguishing device configured to supply the refrigerant to be in direct contact with the battery module.

In the battery fire-extinguishing system according to the present disclosure, the cooling device may comprise a compressor, a condenser, an expansion valve, and an evaporator, through which the refrigerant circulates, wherein at least part of the refrigerant that has passed through the expansion valve is supplied to a refrigerant inlet flow path for heat exchange with the battery module and the refrigerant that has completed the heat exchange with the battery module is retrieved through a refrigerant recovery flow path and then supplied to the cooling device.

The battery fire-extinguishing system according to the present disclosure may further comprise a battery management system (BMS) to detect fires in the battery module and, when the BMS detects fire in the battery module, the fire-extinguishing device may supply to the battery module all the refrigerant that has passed through the expansion valve of the cooling device.

### Effects of the Invention

As described above, according to the present disclosure, risks of ignition or explosions due to the increase in internal temperature and pressure caused by abnormal operations of an electrochemical system may be effectively prevented by using a refrigerant, thereby enhancing safety.

Compared to the conventional techniques that reduce the internal temperature and pressure solely using a safety vent in case of fire in an electrochemical system comprising batteries, the present disclosure provides improved safety.

In addition, the present disclosure does not require any additional complicated fire-extinguishing device for extinguishing fires in an electrochemical system comprising batteries, but instead uses a refrigerant used for the existing cooling device, thereby enabling economical operation and increasing the energy density of a battery pack.

Further, according to the present disclosure, since the refrigerant has insulating properties, a low GWP, and a low vapor pressure, does not fall within a flammable range, and does not remain in a battery after fire-extinguishing unlike the existing fire-extinguishing liquids, it is advantageous for battery recycling.

### BRIEF DESCRIPTION OF THE DRAWINGS

FIG. 1 is a configuration diagram of a battery fire-extinguishing device according to the present disclosure.

FIG. 2 is an example of a battery fire-extinguishing device according to the present disclosure.

FIG. 3 is a diagram illustrating an injecting device according to the present disclosure.

FIG. 4 is another example of a battery fire-extinguishing device according to the present disclosure.

FIG. 5 is an example of a refrigerant tube according to the present disclosure.

FIG. 6 is another example of a refrigerant tube according to the present disclosure.

FIG. 7 is a configuration diagram of a heat pump system according to the present disclosure.

FIG. 8 is an example of a flash tank, which is a component of a heat pump system according to the present disclosure.

FIG. 9 is a configuration diagram illustrating an operation in a cooling mode of a heat pump system according to the present disclosure.

FIG. 10 is a configuration diagram illustrating an operation in a heating mode of a heat pump system according to the present disclosure.

FIG. 11 is a configuration diagram illustrating an operation in an intermediate mode of a heat pump system according to the present disclosure.

FIG. 12 is a configuration diagram of a fire-extinguishing system in a normal state according to the present disclosure.

FIG. 13 is a configuration diagram of a fire-extinguishing system in a state of fire according to the present disclosure.

FIG. 14 is an example showing the application of a fire-extinguishing system according to the present disclosure.

### MODE FOR IMPLEMENTING THE INVENTION

Hereinafter, embodiments of the present disclosure are described in detail with reference to the accompanying drawings. When components in respective drawings are denoted by reference signs, it should be noted that the same components are denoted by the same signs as much as possible even when the components are shown on different drawings. Further, when the present disclosure is described, where it was judged that specific description of related known configurations or functions may obscure the gist of the present disclosure, detailed description thereof has been omitted.

Further, when components of the present disclosure are described, terms such as first, second, A, B, (a), and (b) may be used. These terms are only intended to distinguish the components from other components. The nature, order, or sequence of the components is not limited by the terms. When a component is described as being “connected” or “coupled” to another component, it should be understood that the component may be directly connected or coupled to the other component, but another component may also be “connected” or “coupled” between respective components.

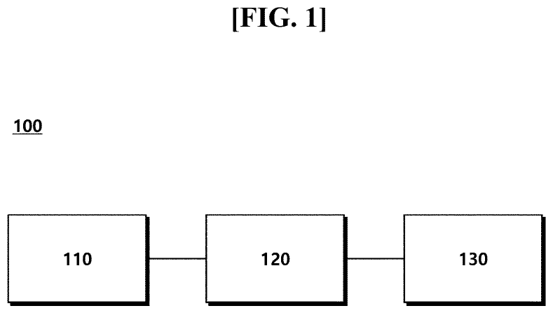

FIG. 1 is a configuration diagram of a battery fire-extinguishing device according to the present disclosure.

Referring to FIG. 1, a fire-extinguishing device 100 for an electrochemical system may comprise an electrochemical system 110, a supplying unit 120, and a storage unit 130.

Here, the electrochemical system 110 may comprise a device generating heat through an electrical or chemical reaction. Specifically, the electrochemical system 110 may be any one of or may include at least one of a battery, a battery cell, a battery module, a battery pack, a battery rack, a hybrid vehicle, an electric vehicle, an energy storage system (ESS), or a distribution board.

Unlike fires occurring generally due to combustion of flammable materials, a fire that occurs in a battery may be in a thermal runaway state, which is an exothermic reaction in which the temperature change further accelerates the temperature change itself. Accordingly, a battery fire may cause subsequent additional explosions, and even when the fire is extinguished, there are still risks of reignition. For this reason, it may be challenging to extinguish fires occurring in batteries in a typical way.

A fire-extinguishing method using water may leave water in a battery device, which may cause corrosion, thereby preventing the battery from being recycled. Accordingly, in case of a battery fire, it may be extinguished by injecting a refrigerant suitable for extinguishing the fire.

The supplying unit 120 may be a component to supply a refrigerant such that the refrigerant may be in direct contact with the electrochemical system 110.

Here, the refrigerant may have insulating properties. Specifically, the refrigerant used for the fire-extinguishing device for the electrochemical system according to the present disclosure may have such low electrical conductivity that no current flows even when the refrigerant is supplied to a battery or a device including a battery. The refrigerant may have an electrical conductivity of 0.1 S/cm or lower, 0.01 S/cm or lower, 0.001 S/cm or lower, 0.0001 S/cm or lower, or even as low as 0 S/cm.

The refrigerant according to the present disclosure may further contain an insulating oil in order to improve the insulating properties.

The refrigerant used for the fire-extinguishing device 100 for the electrochemical system according to the present disclosure may also have a saturated evaporation temperature ranging from −10 °C to 60 °C at normal pressure. Specifically, the refrigerant may have a saturated evaporation temperature of −10 °C or higher, 0 °C or higher, 10 °C or higher, 20 °C or higher, 30 °C or higher, 40 °C or higher, or 50 °C or higher. Additionally, the refrigerant used for the fire-extinguishing device 100 for the electrochemical system according to the present disclosure may have a saturated evaporation temperature of 60 °C or lower, 70 °C or lower, 80 °C or lower, 90 °C or lower, or 100 °C or lower at normal pressure. Here, normal pressure may refer to a typical atmospheric pressure, which is 1 atm. Accordingly, even when the refrigerant is directly injected or discharged into the electrochemical system 110 in case of a fire in the electrochemical system 110, the refrigerant does not remain in the electrochemical system 110, and thus, causes no corrosion compared to that cause by water, which is commonly used as a fire-extinguishing material, and thereby facilitates the recycling of the battery.

In addition, the refrigerant used for the fire-extinguishing device 100 for the electrochemical system according to the present disclosure may be nonflammable. In other words, the refrigerant may not fall within a flammable range and may be classified in the Al group, which indicates a nonflammable group according to the American Society of Heating, Refrigerating and Air-Conditioning Engineers (ASHRAE) Standard 34.

The refrigerant used for the fire-extinguishing device 100 for the electrochemical system according to the present disclosure may be a low-pressure refrigerant. A low-pressure refrigerant may refer to a refrigerant that generally has an evaporation pressure at or below atmospheric pressure.

The refrigerant used for the fire-extinguishing device 100 for the electrochemical system according to the present disclosure may be an environment-friendly refrigerant. In other words, as a refrigerant, a material having a relatively low global warming potential (GWP) may be used. Specifically, the refrigerant according to the present disclosure may have a GWP of 0 or greater, 0.5 or less, 1 or less, 1.5 or less, 2 or less, 2.5 or less, or 3 or less. In addition, as a refrigerant, a material having a relatively low ozone depletion potential (ODP) may be used. Specifically, the refrigerant according to the present disclosure may have an ODP of 0 or greater, 0.1 or less, 0.01 or less, 0.001 or less, 0.0001 or less, or 0.00001 or less.

The refrigerant according to the present disclosure may be supplied with a temperature of 0 °C or lower, more specifically, with a temperature of −5 °C or lower. Such a refrigerant may extinguish fires by being in direct contact with an electrochemical system or an object on fire to lower its temperature, and even by freezing moisture contained in the air to block air. However, the temperature of the supplied refrigerant is not limited, but may be varied depending on the temperature at which an electrochemical system is used. The refrigerant that has absorbed heat from an electrochemical system or an object on fire does not leave any residue after extinguishing the fire. Therefore, corrosion of the electrochemical system may be prevented and the electrochemical system may be readily recycled.

The refrigerant used for the fire-extinguishing device 100 for the electrochemical system according to the present disclosure may contain at least one of methane-based halogenated carbon compounds of refrigerant Nos. 10 to 59, ethane-based halogenated carbon compounds of refrigerant Nos. 110 to 179, propane-based halogenated carbon compounds of refrigerant Nos. 200 to 299, cyclic butane-based halogenated carbon compounds of refrigerant Nos. 300 to 399, non-azeotropic mixed refrigerants of refrigerant Nos. 400 to 499, azeotropic mixed refrigerants of refrigerant Nos. 500 to 599, hydrocarbons, oxygen compounds, sulfur compounds, and nitrogen compounds of refrigerant Nos. 600 to 699, inorganic compounds of refrigerant Nos. 700 to 799, or unsaturated organic compounds of refrigerant Nos. 1000 to 1999 based on the American Society of Heating, Refrigerating and Air-Conditioning Engineers (ASHRAE) Standard 34.

The refrigerant used for the fire-extinguishing device 100 for the electrochemical system according to the present disclosure may include at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A; hydrofluorocarbon refrigerants (HFCs), including R-407A, R-407F, R-410A, R-422D, R-134a, R-507A, R-245fa, R-407C, R-408A, R-404A, R-508B, or R-23; hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

The refrigerant used for the fire-extinguishing device 100 for the electrochemical system according to the present disclosure may further include nanoparticles. The nanoparticles may contain at least one of Au, Ag, Cu, Al, CuO, Co, Fe, TiO2, CNT, GO, or fullerene. The amount of the nanoparticles in the refrigerant may be 1 weight %, 2 weight %, 3 weight %, 4 weight %, 5 weight %, 6 weight %, 7 weight %, 8 weight %, 9 weight %, or 10 weight % or may be greater than 0 weight % and up to 1, 2, 3, 4, 5, 6, 7, 8, 9, or 10 weight %. By being added to the refrigerant, the nanoparticles may serve to further improve the thermal conductivity.

The refrigerant used for the fire-extinguishing device 100 for the electrochemical system according to the present disclosure may also contain a surfactant. Here, the surfactant may be nonflammable so as to be used for extinguishing fires. Specifically, the refrigerant may include at least one of CTAB and Span-80. The surfactant contained in the refrigerant may facilitate the refrigerant's contact with the surface of a burning object when the refrigerant is supplied directly to the object including a battery that is on fire. As such, the refrigerant attached to the surface of a heat-generating device may extinguish the fire by absorbing heat to lower the temperature, and may also prevent thermal runaway, which is a self-sustaining exothermic reaction.

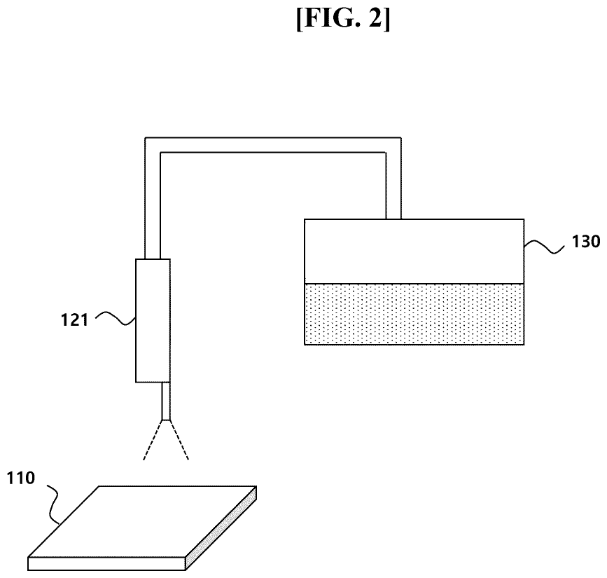

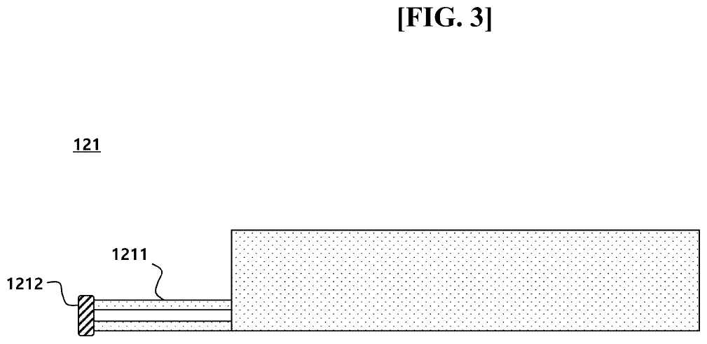

Specified embodiments of the supplying unit 120 are described with reference to FIG. 2 and FIG. 3.

The storage unit 130 may be a component for storing the refrigerant according to the present disclosure.

The refrigerant stored in the storage unit 130 may be transferred to the supplying unit 120 by a pump (not shown) or an additional supplying device, and then may be supplied to the electrochemical system 110 by the supplying unit 120.

Inside the storage unit 130, the pressure may be maintained to be above atmospheric pressure. Specifically, the pressure may be greater than 1 atm or 1 bar, or may be 2 bar or higher or 3 bar or higher, or may be 10 bar or lower. Maintaining the pressure above atmospheric pressure inside the storage unit 130 may enable supplying the refrigerant to the electrochemical system 110 even without a pump (not shown) or an additional supplying device.

The supplying unit 120 and the storage unit 130 may be connected with each other through a component through which the refrigerant can move.

FIG. 2 is an example of a battery fire-extinguishing device according to the present disclosure.

Referring to FIG. 2, the fire-extinguishing device 100 for an electrochemical system according to the present disclosure may comprise the supplying unit 120, and the supplying unit 120 may comprise an injecting device 121 configured to inject refrigerant into the electrochemical system 110 when it is on fire. The injecting device 121 may be supplied with refrigerant from the storage unit 130.

Refrigerant may be injected by the injecting device 121, the injected refrigerant may be in contact with the electrochemical system 110, and the refrigerant in contact with the electrochemical system 110 may absorb heat to extinguish fire and suppress thermal runaway, which is an additional explosive reaction.

The supplied refrigerant has a temperature below zero, specifically, −5 °C or lower so as to absorb heat and even freeze moisture in the air to block oxygen required for combustion in a battery fire situation, which may provide an additional effect in fire suppression.

FIG. 3 is a diagram illustrating an injecting device according to the present disclosure.

Referring to FIG. 3, the injecting device 121 may comprise a nozzle 1211. Refrigerant stored in the storage unit 130 may be supplied to the injecting device 121, and the refrigerant supplied to the injecting device 121 may be injected into the electrochemical system 110 through an injecting hole of the nozzle 1211.

The injecting hole of the nozzle 1211 may be sealed by a thermo-sensitive tube 1212. A thermo-sensitive tube may refer to a component made of a material that melts (runs) or ruptures at a certain temperature when fire occurs. The thermo-sensitive tube 1212 may be made of a special polymer that melts or ruptures in reaction to heat.

Since the injecting hole of the nozzle 1211 is sealed by the thermo-sensitive tube 1212 and the storage unit 130 maintains atmospheric pressure or higher, refrigerant may be supplied to the electrochemical system 110 even without any additional supplying device such as a pump when fire occurs. Specifically, since the injecting hole of the injecting device 121 is sealed by the thermo-sensitive tube 1212 in a normal situation where there is no fire, it may prevent the refrigerant from being discharged, and when fire occurs, the thermo-sensitive tube 1212 located in the injecting hole may melt or rupture due to heat generated by fire so that the refrigerant may be discharged from the storage unit 130, which maintains a pressure above atmospheric pressure, by means of the pressure, even without any additional supplying device.

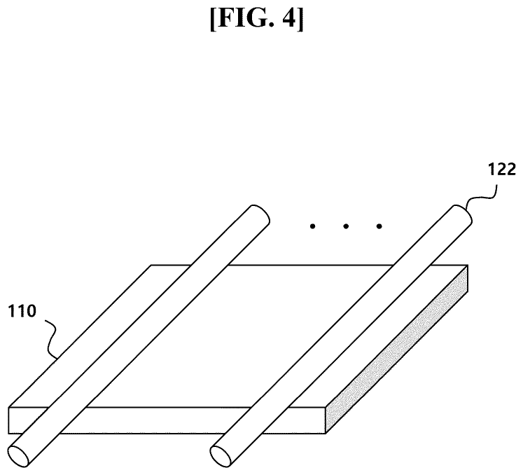

FIG. 4 is another example of a battery fire-extinguishing device according to the present disclosure.

Referring to FIG. 4, the fire-extinguishing device 100 for an electrochemical system according to the present disclosure may comprise the supplying unit 120, and the supplying unit 120 may comprise a refrigerant tube 122.

The refrigerant tube 122 may be supplied with refrigerant from the storage unit 130 and may manage heat for normal operations of the electrochemical system 110 in a normal situation where there is no fire in the electrochemical system 110. A battery generally operates at optimal performance at 10 °C to 40 °C. The refrigerant tube 122 exchanges heat with the electrochemical system 110 so that the electrochemical system 110 may maintain its optimal temperature.

The refrigerant tube 122 may be disposed in direct contact with the electrochemical system 110 for heat exchange with the electrochemical system 110. The refrigerant tube 122 may be made of a thermally conductive material. Here, a thermally conductive material may include a metal or a thermally conductive plastic. However, the present disclosure is not limited thereto, and various materials having thermal conductivity may be used.

The refrigerant tube 122 may rupture or melt when fire occurs (when fire ignites) in the electrochemical system 110 so that refrigerant contained in the refrigerant tube 122 may be supplied to the electrochemical system 110. That is, the refrigerant may be released or discharged into direct contact with the electrochemical system 110 so as to suppress fire and thermal runaway occurring in the electrochemical system 110.

At least part of the refrigerant tube 122 may be thermo-sensitive. When fire occurs in the electrochemical system 110 (when the system ignites), the at least thermo-sensitive part of the refrigerant tube 122 may melt or rupture due to heat and be removed, and then, refrigerant contained in the refrigerant tube 122 may be discharged or released directly into the electrochemical system 110.

The fire-extinguishing device 100 for an electrochemical system according to the present disclosure may comprise one or more refrigerant tubes 122. The fire-extinguishing device 100 for an electrochemical system shown in FIG. 4 is merely an example. The configuration or arrangement of the refrigerant tubes 122 may be variously modified.

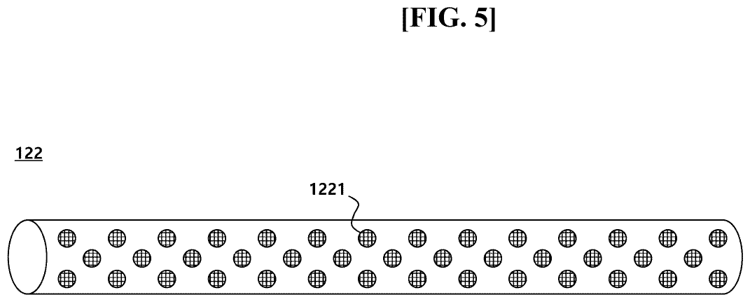

FIG. 5 is an example of a refrigerant tube according to the present disclosure.

Referring to FIG. 5, the refrigerant tube 122 according to the present disclosure may comprise one or more circular thermo-sensitive portions 1221 (thermo-sensitive tube).

When fire occurs in the electrochemical system 110, the thermo-sensitive portions 1221 of the refrigerant tube 122 may melt or rupture due to heat generated by fire, thereby forming holes in the refrigerant tube 122. Through the holes formed by heat, refrigerant contained in the refrigerant tube 122 may be released or discharged outside the refrigerant tube 122 and may be supplied into direct contact with the electrochemical system 110, thereby extinguishing fire and thermal runaway.

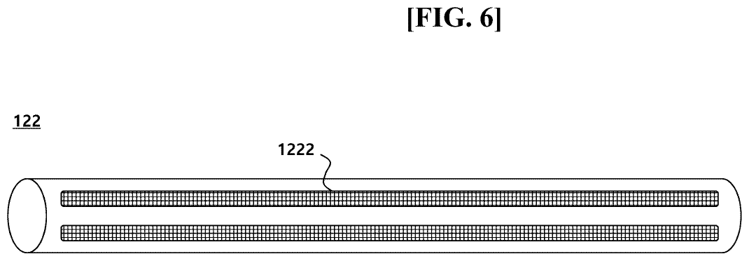

FIG. 6 is another example of a refrigerant tube according to the present disclosure.

Referring to FIG. 6, the refrigerant tube 122 according to the present disclosure may comprise one or more linear thermo-sensitive portions 1222.

When fire occurs in the electrochemical system 110, the thermo-sensitive portions 1222 of the refrigerant tube 122 may melt or rupture due to heat generated by fire, thereby forming linear openings in the refrigerant tube 122. Through the openings formed by heat, refrigerant contained in the refrigerant tube 122 may be released or discharged outside the refrigerant tube 122 and may be supplied into direct contact with the electrochemical system 110, thereby extinguishing fire and thermal runaway.

In a heated runaway state, the temperature of a lithium-ion secondary battery may generally increase to between 188 °C and 527 °C, thereby causing the lithium-ion secondary battery to be heated and ignited. In an overcharge-induced thermal runaway state, the temperature of a lithium-ion secondary battery may increase to between 110 °C and 317 °C, thereby causing the lithium-ion secondary battery to be heated and ignited. The fire-extinguishing device 100 for an electrochemical system according to the present disclosure enables extinguishing and suppressing such ignition and thermal runaway by lowering the temperature of the electrochemical system and even by blocking oxygen to prevent additional fire damage.

The normal operative temperature of a battery may range from 20 °C to 60 °C, from 30 °C to 50 °C, or about 40 °C. The fire-extinguishing device 100 for an electrochemical system according to the present disclosure may extinguish fire when fire occurs, and also maintain the temperature of an electrochemical system at an appropriate level using refrigerant. Specifically, the fire-extinguishing device may supply heat when the temperature of the electrochemical system is too low, and may absorb heat when the temperature of the electrochemical system is too high.

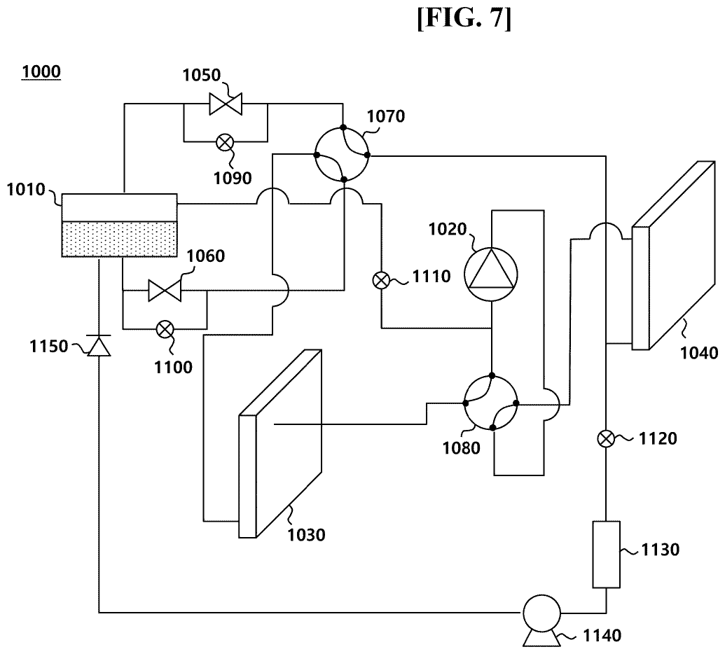

FIG. 7 is a configuration diagram of a heat pump system according to the present disclosure.

Referring to FIG. 7, a heat pump system 1000 according to the present disclosure may comprise a flash tank 1010, a compressor 1020, a first heat exchanger 1030, a second heat exchanger 1040, a first expansion valve 1050, a second expansion valve 1060, a first four-way valve 1070, a second four-way valve 1080, a first valve 1090, a second valve 1100, a third valve 1110, and a fourth valve 1120.

The heat pump system 1000 according to the present disclosure may also comprise a storage unit 1130, a pump 1140, and a check valve 1150.

In the heat pump system 1000 according to the present disclosure, refrigerant may circulate as an operating fluid.

The flash tank 1010 may be a component for storing refrigerant in a gaseous or liquid state. The flash tank 1010 may comprise a device 1160 that generates heat from an electrical or chemical reaction. In the flash tank 1010, refrigerant and the device 1160 may exchange heat with each other, and when fire occurs in the device 1160, the fire may be extinguished by the refrigerant stored in the flash tank 1010.

The compressor 1020 may be a component for compressing refrigerant into high-temperature refrigerant. Specifically, the compressor may compress low-temperature and low-pressure refrigerant in a gaseous state into a high-temperature and high-pressure refrigerant.

Referring to FIG. 7, the compressor 1020 according to the present disclosure may be connected to the flash tank 1010, and the third valve may be disposed between the flash tank 1010 and the compressor 1020. The compressor 1020 may further be connected to the second four-way valve 1080. The compressor 1020 may also be connected to the first heat exchanger 1030 and the second heat exchanger 1040 through the second four-way valve 1080.

The first heat exchanger 1030 and the second heat exchanger 1040 may be components through which refrigerant passes and in which heat is exchanged. The first heat exchanger 1030 and the second heat exchanger 1040 may serve as an evaporator or a condenser.

Here, an evaporator may be a component in which refrigerant absorbs heat, and specifically, in which low-temperature liquid refrigerant absorbs heat and changes into gaseous refrigerant. A condenser may be a component in which refrigerant releases heat, and specifically, in which high-temperature and high-pressure gaseous refrigerant releases heat and changes into liquid refrigerant.

The first heat exchanger 1030 according to the present disclosure may be connected to the first four-way valve 1070 and the second four-way valve 1080. The first heat exchanger 1030 may be selectively connected to the first expansion valve 1050 or the second expansion valve 1060 through the first four-way valve 1070 and may be selectively connected to the compressor 1020 through the second four-way valve 1080. Here, a selective connection may refer to a configuration in which connections between the respective components may vary depending on an operating mode of the heat pump system 1000.

The second heat exchanger 1040 according to the present disclosure may be connected to the first four-way valve 1070 and the second four-way valve 1080. The second heat exchanger 1040 may be selectively connected to the first expansion valve 1050 or the second expansion valve 1060 through the first four-way valve 1070 and may be selectively connected to the compressor 1020 through the second four-way valve 1080.

The first heat exchanger 1030 and the second heat exchanger 1040 according to the present disclosure may perform opposite functions, respectively. Specifically, when the first heat exchanger 1030 serves as a condenser, the second heat exchanger 1040 may serve as an evaporator, or when the first heat exchanger 1030 serves as an evaporator, the second heat exchanger 1040 may serve as a condenser.

The first expansion valve 1050 and the second expansion valve 1060 may be components for lowering the pressure of refrigerant by volume expansion. Specifically, these valves may decrease pressure and temperature by reducing the pressure of liquid refrigerant so that the refrigerant may be in a gaseous state, a liquid state, or a gas-liquid mixed state.

The first expansion valve 1050 may supply low-temperature and low-pressure refrigerant to the flash tank 1010 and may be turned on or off depending on the operating mode of the heat pump system 1000. Here, ‘on’ refers to a state in which the first expansion valve operates to allow refrigerant to pass through, and ‘off’ refers to a state in which the valve does not operate and refrigerant does not pass through.

The first expansion valve 1050 may be connected to the first four-way valve 1070 and to the first heat exchanger 1030 or the second heat exchanger 1040, depending on the operating mode.

The second expansion valve 1060 may be supplied with refrigerant from the flash tank 1010 and may supply the refrigerant to the first four-way valve 1070. It may selectively supply refrigerant through the first four-way valve 1070 to the first heat exchanger 1030 or the second heat exchanger 1040 depending on the operating mode of the heat pump system 1000 according to the present disclosure. The second expansion valve 1060 may also be turned on or off depending on the operating mode of the heat pump system 1000.

The first four-way valve 1070 and the second four-way valve 1080 may be components that vary connection paths depending on the operating mode. Accordingly, the first four-way valve 1070 may be a component that selectively connects the flash tank 1010, the first heat exchanger 1030, the second heat exchanger 1040, and the first expansion valve 1050 to one another. The second four-way valve 1080 may be a component that selectively connects the compressor 1020, the first heat exchanger 1030, and the second heat exchanger 1040 to one another. Here, a selective connection may refer to a configuration in which connections between the respective components may vary depending on an operating mode of the heat pump system 1000.

The first valve 1090, the second valve 1100, the third valve 1110, and the fourth valve 1120 may be components that control flow of refrigerant by being turned on or off. The first to the fourth valves 1090, 1100, 1110, 1120 may be solenoid valves. However, the present disclosure is not limited thereto, and the types of valves may vary as necessary.

The first valve 1090 may be connected with the first expansion valve 1050 in parallel and may be turned on or off depending on the operating mode of the heat pump system 1000. When the first valve 1090 is turned on, the first expansion valve 1050 may be turned off, and when the first valve 1090 is turned off, the first expansion valve 1050 may be turned on. The second valve 1100 may be connected with the second expansion valve 1060 in parallel and may be turned on or off depending on the operating mode of the heat pump system 1000. When the second valve 1100 is turned on, the second expansion valve 1060 may be turned off, and when the second valve 1100 is turned off, the second expansion valve 1060 may be turned on.

The third valve 1110 may be disposed between the flash tank 1010 and the compressor 1020. The third valve 1110 may be turned on or off depending on the operating mode of the heat pump system 1000, thereby determining whether refrigerant from the flash tank 1010 is supplied to the compressor 1020. Refrigerant passing through the third valve 1110 may be in at least one of a liquid state and a gaseous state.

The fourth valve 1120 may be disposed between the second heat exchanger 1040 and the flash tank 1010. The fourth valve 1120 may be turned on or off depending on the operating mode of the heat pump system 1000, thereby determining whether refrigerant from the second heat exchanger 1040 is supplied to the flash tank 1010.

The storage unit 1130 may be disposed between the flash tank 1010 and the second heat exchanger 1040. It may be a component that temporarily stores refrigerant in a liquid state.

The pump 1140 and the check valve 1150 may be disposed between the flash tank 1010 and the second heat exchanger 1040. The pump 1140 may supply energy so that refrigerant from the second heat exchanger 1040 may be transferred to the flash tank 1010, and the check valve 1150 may be a component that prevents refrigerant from the second heat exchanger 1040 from flowing backward.

Each component of the heat pump system 1000 may be added or removed as necessary and their disposition and connection may vary as necessary.

Refrigerant used for the heat pump system 1000 according to the present disclosure may have insulating properties and may also be environmentally friendly.

Refrigerant used for the present disclosure may have a saturated evaporation temperature of −10 °C or higher and 60 °C or lower at normal pressure. Specifically, the refrigerant may have a saturated evaporation temperature of −10 °C or higher, 0 °C or higher, 10 °C or higher, 20 °C or higher, 30°C or higher, 40 °C or higher, or 50 °C or higher at normal pressure. Additionally, the refrigerant may have a saturated evaporation temperature of 60 °C or lower, 70 °C or lower, 80 °C or lower, 90 °C or lower, or 100 °C or lower at normal pressure. Here, normal pressure refers to typical atmospheric pressure, which may refer to 1 atm. Accordingly, even when fire occurs in a battery or a device including battery, and refrigerant is directly injected or discharged into the battery or the device, the refrigerant does not remain, and thus, does not cause problems such as corrosion compared to water generally used as a fire-extinguishing material, thereby enabling reuse of the battery.

Refrigerant used for the present disclosure may be a low-pressure refrigerant. A low-pressure refrigerant may refer to a refrigerant generally having an evaporation pressure at or below atmospheric pressure.

Refrigerant used for the present disclosure may be non-flammable, that is, it may not fall within the flammable range, and may be a refrigerant classified as Group A1, indicating non-29 flammability based on Standard 34 of the American Society of Heating, Refrigerating and Air-Conditioning Engineers (ASHRAE).

Refrigerant used for the present disclosure may have such low electrical conductivity that, even when the refrigerant is supplied to a battery or a device including a battery, no current flows. Specifically, refrigerant may have an electrical conductivity of 0.1 S/cm or lower, 0.01 S/cm or lower, 0.001 S/cm or lower, or 0.0001 S/cm or lower, or even 0 S/cm.

Refrigerant used for the present disclosure may be environmentally friendly, that is, a material with a relatively low global warming potential (GWP) may be used as refrigerant. Specifically, refrigerant used for the present disclosure may have a GWP of 0 or higher, 0.5 or lower, 1 or lower, 1.5 or lower, 2 or lower, 2.5 or lower, or 3 or lower. Additionally, a material with a relatively low ozone depletion potential (ODP) may be used as refrigerant. Specifically, refrigerant used for the present disclosure may have an ODP of 0 or higher, 0.1 or lower, 0.01 or lower, 0.001 or lower, 0.0001 or lower, or 0.00001 or lower.

Refrigerant according to the present disclosure may contain at least one of methane-based halogenated carbon compounds with refrigerant numbers in the 10 to 50 range, ethane-based halogenated carbon compounds with refrigerant numbers in the 110 to 170 range, propane-based halogenated carbon compounds with refrigerant numbers in the 200 to 290 range, cyclic butane-based halogenated carbon compounds with refrigerant numbers in the C300 range, non-azeotropic mixed refrigerants with refrigerant number in the 400 range, azeotropic mixed refrigerants with refrigerant numbers in the 500 range, hydrocarbons, oxygen compounds, sulfur compounds, and nitrogen compounds with refrigerant number in the 600 range, inorganic compounds with refrigerant number in the 700 range, or unsaturated organic compounds with refrigerant numbers in the 1000 range, based on the American Society of Heating, Refrigerating and Air-Conditioning Engineers (ASHRAE) Standard 34.

Refrigerant according to the present disclosure may include at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A; hydrofluorocarbon refrigerants (HFCs), including R-407A, R-407F, R-410A, R-422D, R-134a, R-507A, R-245fa, R-407C, R-408A, R-404A, R-508B, or R-23; hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

Refrigerant according to the present disclosure may further include nanoparticles. The nanoparticles may contain at least one of Au, Ag, Cu, Al, CuO, Co, Fe, TiO2, CNT (Carbon Nano Tube), GO (Graphene Oxide), and fullerene. The amount of the nanoparticles in the refrigerant may be 1 weight %, 2 weight %, 3 weight %, 4 weight %, 5 weight %, 6 weight %, 7 weight %, 8 weight %, 9 weight %, or 10 weight % or may be greater than 0 weight % and up to 1, 2, 3, 4, 5, 6, 7, 8, 9, or 10 weight %. By being added to the refrigerant, the nanoparticles may serve to further improve thermal conductivity.

The refrigerant according to the present disclosure may also contain a surfactant. Here, the surfactant may be nonflammable so as to be used for extinguishing fires. Specifically, the refrigerant may include at least one of CTAB and Span-80. The surfactant contained in the refrigerant may facilitate the refrigerant's contact with the surface of a burning object when the refrigerant is supplied directly to the object including a battery, that is on fire. As such, the refrigerant attached to the surface of a heat-generating device may extinguish the fire by absorbing heat to lower the temperature, and may also prevent thermal runaway, which is a self-sustaining exothermic reaction.

The refrigerant according to the present disclosure may further contain an insulating oil in order to improve the insulating properties. The refrigerant may contain an insulating oil in an amount of 1 weight %, 2 weight %, 3 weight %, 4 weight %, 5 weight %, 6 weight %, 7 weight %, 8 weight %, 9 weight %, or 10 weight % or in an amount greater than 0 weight % and up to 1, 2, 3, 4, 5, 6, 7, 8, 9, or 10 weight %.

The temperature of the refrigerant according to the present disclosure to be supplied may be 0 °C or lower, and more specifically, −5 °C or lower. Such refrigerant may be in direct contact with an object that is on fire to lower the temperature of the object and to extinguish fire, and may also freeze moisture contained in the air to block air, thereby extinguishing fire. However, the temperature of the refrigerant to be supplied is not limited thereto, but may vary depending on the temperature of a place where the refrigerant is used. Additionally, the refrigerant that has absorbed heat from the object on fire does not leave any residue, and thus, a device such as battery may be prevented from corrosion and have improved recyclability.

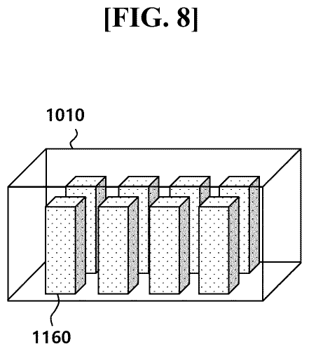

FIG. 8 is an example of a flash tank, which is a component of a heat pump system according to the present disclosure.

Referring to FIG. 8, a device 1160 may be disposed inside the flash tank 1010. The device 1160 that generates heat may be in direct contact with gas or liquid stored in the flash tank 1010.

Here, the device 1160 may include a battery cell, a battery module, a battery pack, a battery rack, a hybrid vehicle, an electric vehicle, an energy storage system, or a distribution board. That is, the refrigerant according to the present disclosure may be variously used in electronic apparatuses or mechanical apparatuses that generate heat.

The heat pump system 1000 according to the present disclosure may be variously used in electronic apparatuses or mechanical apparatuses that generate heat, as well as in batteries.

Additionally, the heat pump system 1000 according to the present disclosure may operate in a cooling mode, a heating mode, or an intermediate mode.

In a heated runaway state, the temperature of a lithium-ion secondary battery may generally increase to between 188 °C and 527 °C, thereby causing the lithium-ion secondary battery to be heated and ignited. In an overcharge-induced thermal runaway state, the temperature of a lithium-ion secondary battery may increase to between 110 °C and 317 °C, thereby causing the lithium-ion secondary battery to be heated and ignited. The heat pump system 1000 according to the present disclosure enables lowering the temperature of the device to extinguish and suppress such ignition and thermal runaway, and blocking oxygen to prevent additional fire damage.

The temperature for normal operations of a battery may be between 20 °C and 60 °C, between 30 °C and 50 °C, or about 40 °C. The heat pump system 1000 according to the present disclosure, which extinguishes fire when it occurs, may also maintain the device 1160 at an appropriate temperature using refrigerant. That is, the heat pump system may supply heat when the temperature of the device 1160 is too low and may absorb heat when the temperature of the device is too high.

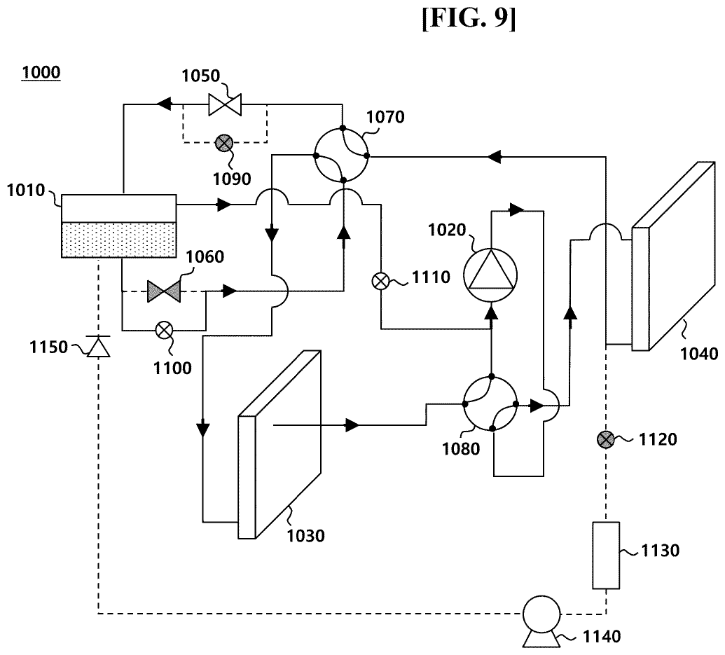

FIG. 9 is a configuration diagram illustrating an operation in a cooling mode of a heat pump system according to the present disclosure.

Referring to FIG. 9, when the heat pump system 1000 according to the present disclosure operates in a cooling mode, refrigerant in a gaseous state in the flash tank 1010 may circulate sequentially through the third valve 1110, the compressor 1020, the second four-way valve 1080, the second heat exchanger 1040, which serves as a condenser, then through the first four-way valve 1070, and the first expansion valve 1050, and may be supplied back to the flash tank 1010 in a low-temperature and low-pressure state. Refrigerant in a liquid state in the flash tank 1010 may circulate sequentially through the second valve 1100, the first four-way valve 1070, the first heat exchanger 1030, which serves as an evaporator, then through the second four-way valve 1080, the compressor 1020, the second heat exchanger 1040, which serves as a condenser, then through the first four-way valve 1070, and the first expansion valve 1050, and may be supplied back to the flash tank 1010 in a low-temperature and low-pressure state.

Referring to FIG. 9 again, when the heat pump system 1000 according to the present disclosure operates in a cooling mode, the second expansion valve 1060, the first valve 1090, and the fourth valve 1120 may be in the off state.

Since the low-temperature refrigerant that has passed through the first expansion valve 1050 is supplied to the flash tank 1010, the device 1160 included in the flash tank 1010 may exchange heat with the refrigerant and be cooled.

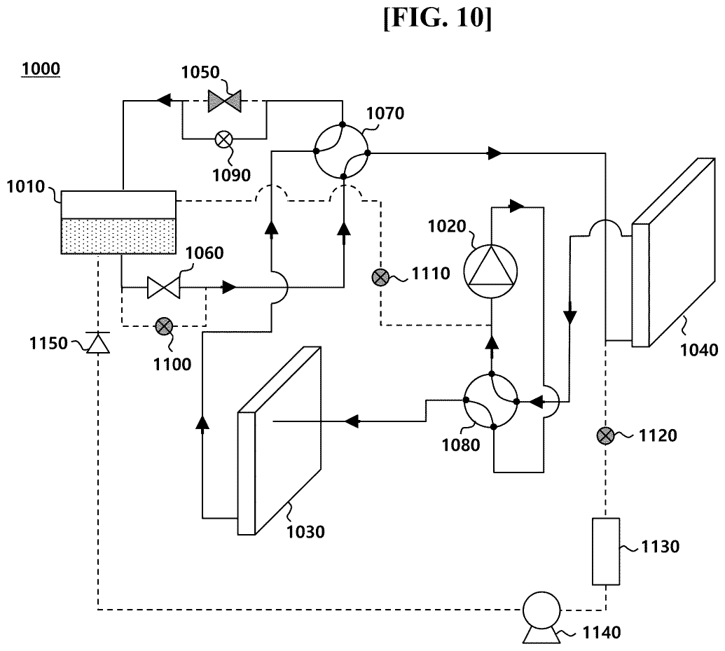

FIG. 10 is a configuration diagram illustrating an operation in a heating mode of a heat pump system according to the present disclosure.

Referring to FIG. 10, when the heat pump system 1000 according to the present disclosure operates in a heating mode, refrigerant in a liquid state in the flash tank 1010 may circulate sequentially through the second expansion valve 1060, the first four-way valve 1070, the second heat exchanger 1040, which serves as an evaporator, then through the second four-way valve 1080, the compressor 1020, the first heat exchanger 1030, which serves as a condenser, then through the first four-way valve 1070, and the first valve 1090, and may be supplied back to the flash tank 1010 in a liquid state.

Referring to FIG. 10 again, when the heat pump system 1000 according to the present disclosure operates in a heating mode, the first expansion valve 1050, the second valve 1100, the third valve 1110, and the fourth valve 1120 may be in the off state.

Liquid refrigerant that has passed through the compressor 1020 and the first heat exchanger 1030, which serves as a condenser, may be in a relatively warm (high-temperature) state. When such refrigerant is supplied to the flash tank 1010, the device 1160 included in the flash tank 1010 may exchange heat with the refrigerant and be heated. There is an appropriate temperature for a battery or a device including a battery to operate normally and when the temperature of a battery or a device is too low, the battery or the device may not operate normally. Accordingly, the battery or the device is required to maintain its appropriate temperature.

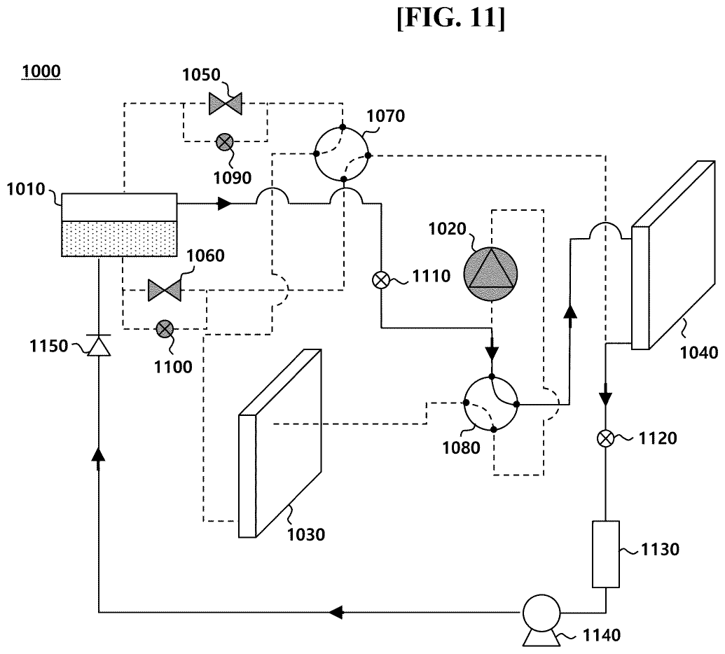

FIG. 11 is a configuration diagram illustrating an operation in an intermediate mode of a heat pump system according to the present disclosure.

Referring to FIG. 11, when the heat pump system 1000 according to the present disclosure operates in an intermediate mode, refrigerant in a gaseous state in the flash tank 1010 may circulate sequentially through the third valve 1110, the second four-way valve 1080, and the second heat exchanger 1040, and may be supplied back to the flash tank 1010. Here, the refrigerant in a gaseous state may undergo a phase change into a liquid state through the second heat exchanger 1040. The heat pump system 100 may also comprise a storage unit 1130, a pump 1140, and a check valve 1150. The storage unit 1130 may be a component for temporarily storing refrigerant in a liquid state that has passed through the fourth valve 1120, the pump 1140 may be a component for providing power to allow the refrigerant to reach the flash tank 1010, and the check valve 1150 may be a component for preventing the refrigerant from flowing backward.

The intermediate mode of the heat pump system 1000 may be a mode for a case in which neither cooling nor heating is required.

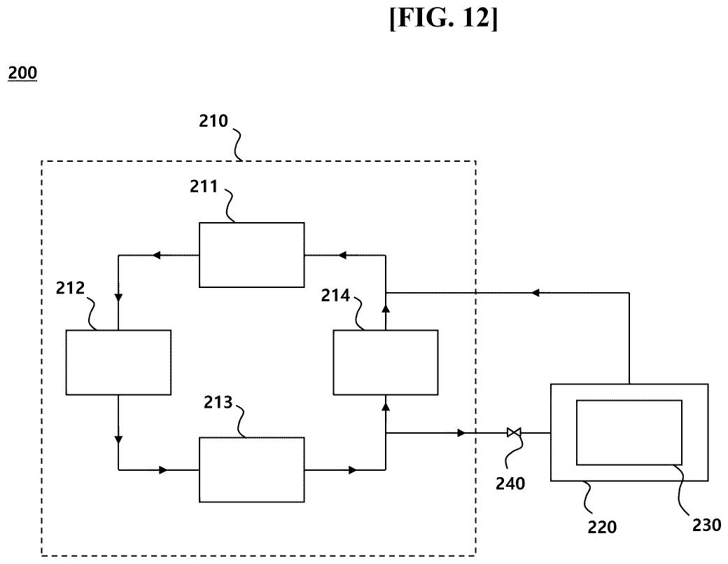

FIG. 12 is a configuration diagram of a fire-extinguishing system in a normal state according to the present disclosure.

Referring to FIG. 12, a battery fire-extinguishing system 200 according to the present disclosure may comprise a cooling device 210, a fire-extinguishing device 220, and a battery module 230. In the battery fire-extinguishing system 200, refrigerant may circulate in a fluid state, and the battery fire-extinguishing system 200 may also include a flow rate adjusting valve 240 that adjusts the flow rate of the refrigerant flowing from the cooling device 210 to the fire-extinguishing device 220. The cooling device 210 may comprise a compressor 211, a condenser 212, an expansion valve 213, and an evaporator 214. Here, the battery module 230 may be a component that includes a battery cell.

A normal state of the battery fire-extinguishing system 200 according to the present disclosure may refer to a state in which there is no fire present in the battery module 230.

Refrigerant may circulate through the cooling device 210, which is one component according to the present disclosure. Part of the refrigerant from the expansion valve 213 may be supplied to the fire-extinguishing device 220, and the remaining part may be supplied to the evaporator 214. The fire-extinguishing device 220 may be supplied with refrigerant from the cooling device 210 through a refrigerant inflow path and may return the refrigerant to the cooling device 210 through a refrigerant return path to resupply the refrigerant.

The fire-extinguishing device 220 may supply refrigerant to be in direct contact with the battery module 230, and thus, the refrigerant may exchange heat with the battery module 230.

The battery fire-extinguishing system 200 according to the present disclosure may further comprise a battery management system (BMS) (not shown) that is configured to detect fire in the battery module 230. The BMS may be a component of the battery fire-extinguishing system 200 or a component of the fire-extinguishing device 220.

Refrigerant used for the battery fire-extinguishing system 200 according to the present disclosure may have insulating properties. It may also have environmentally friendly properties.

Refrigerant according to the present disclosure may have a saturated evaporation temperature ranging from −10 °C to 60 °C at normal pressure. Specifically, refrigerant may have a saturated evaporation temperature of −10 °C or higher, 0 °C or higher, 10 °C or higher, 20 °C or higher, 30 °C or higher, 40 °C or higher, or 50 °C or higher. In addition, the refrigerant according to the present disclosure may have a saturated evaporation temperature of 60 °C or lower, 70 °C or lower, 80 °C or lower, 90 °C or lower, or 100 °C or lower at normal pressure. Here, the normal pressure may indicate typical atmospheric pressure, which is 1 atm. Accordingly, even when the refrigerant is directly injected or discharged into a battery or a device including a battery in the event of a fire in the battery or the device, the refrigerant does not remain in the battery or the device, and thus, causes no problem such as corrosion compared to water, which is commonly used as a fire-extinguishing material, thereby facilitating the recycling of the battery.

Refrigerant according to the present disclosure may be a low-pressure refrigerant. A low-pressure refrigerant may refer to a refrigerant that generally has an evaporation pressure at or below atmospheric pressure.

Refrigerant used for the present disclosure may be non-flammable, that is, it may not fall within a flammable range, and may be a refrigerant classified as Group A1, indicating non-flammability based on Standard 34 of the American Society of Heating, Refrigerating and Air-Conditioning Engineers (ASHRAE).

Refrigerant used for the present disclosure may have such low electrical conductivity that, even when the refrigerant is supplied to a battery or a device including a battery, no current flows. Specifically, the refrigerant may have electrical conductivity of 0.1 S/cm or lower, 0.01 S/cm or lower, 0.001 S/cm or lower, or 0.0001 S/cm or lower, or even 0 S/cm.

Refrigerant used for the present disclosure may be environmentally friendly, in other words, a material with a relatively low global warming potential (GWP) may be used as refrigerant. Specifically, refrigerant used for the present disclosure may have a GWP of 0 or higher, 0.5 or lower, 1 or lower, 1.5 or lower, 2 or lower, 2.5 or lower, or 3 or lower. Additionally, a material with a relatively low ozone depletion potential (ODP) may be used as refrigerant.

Specifically, refrigerant used for the present disclosure may have an ODP of 0 or higher, 0.1 or lower, 0.01 or lower, 0.001 or lower, 0.0001 or lower, or 0.00001 or lower.

Refrigerant according to the present disclosure may contain at least one of methane-based halogenated carbon compounds with refrigerant numbers in the 10 to 50 range, ethane-based halogenated carbon compounds with refrigerant numbers in the 110 to 170 range, propane-based halogenated carbon compounds with refrigerant numbers in the 200 to 290 range, cyclic butane-based halogenated carbon compounds with refrigerant numbers in the C300 range, non-azeotropic mixed refrigerants with refrigerant number in the 400 range, azeotropic mixed refrigerants with refrigerant numbers in the 500 range, hydrocarbons, oxygen compounds, sulfur compounds, and nitrogen compounds with refrigerant number in the 600 range, inorganic compounds with refrigerant number in the 700 range, or unsaturated organic compounds with refrigerant numbers in the 1000 range, based on the American Society of Heating, Refrigerating and Air-Conditioning Engineers (ASHRAE) Standard 34.

Refrigerant according to the present disclosure may include at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A; hydrofluorocarbon refrigerants (HFCs), including R-407A, R-407F, R-410A, R-422D, R-134a, R-507A, R-245fa, R-407C, R-408A, R-404A, R-508B, or R-23; hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

Refrigerant according to the present disclosure may further include nanoparticles. The nanoparticles may contain at least one of Au, Ag, Cu, Al, CuO, Co, Fe, TiO2, CNT (Carbon Nano Tube), GO (Graphene Oxide), and fullerene. The amount of the nanoparticles in the refrigerant may be 1 weight %, 2 weight %, 3 weight %, 4 weight %, 5 weight %, 6 weight %, 7 weight %, 8 weight %, 9 weight %, or 10 weight % or may be greater than 0 weight % and up to 1, 2, 3, 4, 5, 6, 7, 8, 9, or 10 weight %. By being added to the refrigerant, the nanoparticles may serve to further improve thermal conductivity.

The refrigerant according to the present disclosure may also contain a surfactant. Here, the surfactant may be nonflammable so as to be used for extinguishing fires. Specifically, the refrigerant may include at least one of CTAB and Span-80. The surfactant contained in the refrigerant may facilitate the refrigerant's contact with the surface of a burning object when the refrigerant is supplied directly to the object including a battery that is on fire. As such, the refrigerant attached to the surface of a heat-generating device may extinguish the fire by absorbing heat to lower the temperature, and may also prevent thermal runaway, which is a self-sustaining exothermic reaction.

The refrigerant according to the present disclosure may further contain an insulating oil in order to improve the insulating properties. The refrigerant may contain the insulating oil in an amount of 1 weight %, 2 weight %, 3 weight %, 4 weight %, 5 weight %, 6 weight %, 7 weight %, 8 weight %, 9 weight %, or 10 weight % or in an amount greater than 0 weight % and up to 1, 2, 3, 4, 5, 6, 7, 8, 9, or 10 weight %.

In a heated runaway state, the temperature of a lithium-ion secondary battery may generally increase to between 188 °C and 527 °C, thereby causing the lithium-ion secondary battery to be heated and ignited. In an overcharge-induced thermal runaway state, the temperature of a lithium-ion secondary battery may increase to between 110 °C and 317 °C, thereby causing the lithium-ion secondary battery to be heated and ignited. The battery fire-extinguishing system 200 according to the present disclosure enables lowering the temperature of the battery module 230 to extinguish and suppress such ignition and thermal runaway, and blocking oxygen to prevent additional fire damage.

The normal operative temperature of a battery may range from 20 °C to 60 °C, from 30 °C to 50 °C, or about 40 °C. The battery fire-extinguishing system 200 according to the present disclosure may extinguish fire when fire occurs, and also maintain the temperature of the battery module 230 at an appropriate level using refrigerant. Specifically, the battery fire-extinguishing system 200 may supply heat when the temperature of the battery module 230 is too low, and may absorb heat when the temperature of the battery module 230 is too high.

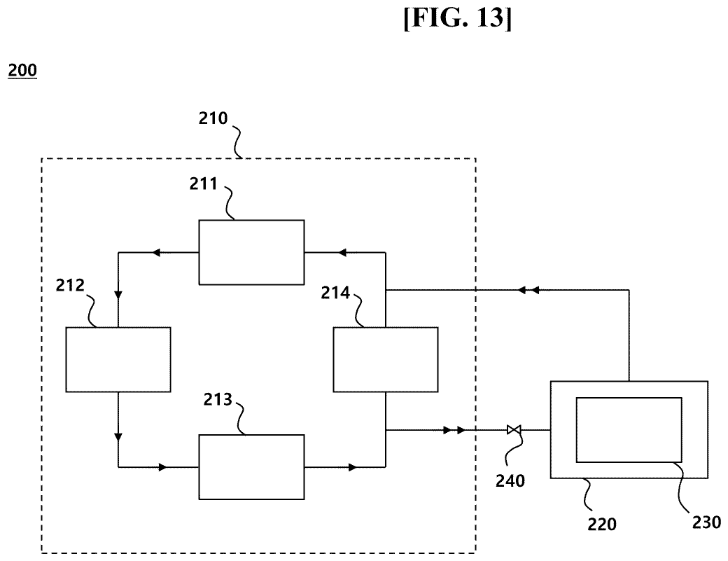

FIG. 13 is a configuration diagram of a fire-extinguishing system in a state of fire according to the present disclosure.

Referring to FIG. 13, the battery fire-extinguishing system 200 according to the present disclosure may operate in various ways. Specifically, when fire occurs in the battery module 230, the entire amount of refrigerant output from the expansion valve 213 among refrigerant circulating through the cooling device 210 may be supplied to the fire-extinguishing device 220. The refrigerant may come into direct contact with the battery module 230 to extinguish fire. Then, the refrigerant may return through the refrigerant return path.

The temperature of the refrigerant according to the present disclosure to be supplied may be 0 °C or lower, and more specifically, −5 °C or lower. Such refrigerant may be in direct contact with an object that is on fire to lower the temperature of the object and to extinguish fire, and may also freeze moisture contained in the air to block air, thereby extinguishing fire. The temperature of the refrigerant to be supplied is not limited thereto, but may vary depending on the temperature of a place where the refrigerant is used. Additionally, the refrigerant that has absorbed heat of the object on fire does not leave any residue, and thus, a device such as battery may be prevented from corrosion and have improved recyclability.

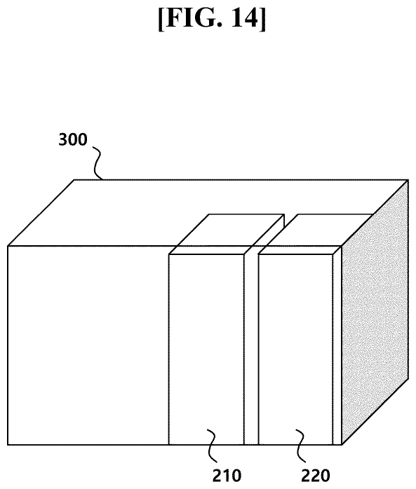

FIG. 14 is an example showing the application of a fire-extinguishing system according to the present disclosure.

Referring to FIG. 14, the battery fire-extinguishing system 200 according to the present disclosure may be applied to a battery pack 300. Specifically, the cooling device 210 and the fire-extinguishing device 220 may be applied to the battery pack 300. Here, the cooling device 210 and the fire-extinguishing device 220 may be applied in the form of a single component.

Since the battery fire-extinguishing system 200 according to the present disclosure is applied to the battery pack 300, it may exchange heat with the battery pack 300 using refrigerant and may extinguish fire by supplying the refrigerant into direct contact with the battery pack 300 when it is on fire.

Since terms, such as “including,” “comprising,” and “having” mean that corresponding elements may exist unless they are specifically described to the contrary, it shall be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than in an overly idealized or impractical manner, unless the present disclosure expressly defines them so.

Although a preferred embodiment of the present disclosure has been described for illustrative purposes, those skilled in the art will appreciate that various modifications, additions, and substitutions are possible without departing from the scope and spirit of the embodiment as disclosed in the accompanying claims. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

1. A fire-extinguishing device for an electrochemical system using a refrigerant, comprising:
a supplying unit configured to supply the refrigerant to be in direct contact with the electrochemical system; and
a storage unit configured to store the refrigerant.

2. The fire-extinguishing device for an electrochemical system of claim 1,
wherein the supplying unit comprises an injecting device configured to inject the refrigerant into the electrochemical system when a fire occurs in this system.

3. The fire-extinguishing device for an electrochemical system of claim 2,
wherein the injecting device comprises a nozzle through which the refrigerant is injected, wherein an injection hole of the nozzle is sealed with a thermo-sensitive tube.

4. The fire-extinguishing device for an electrochemical system of claim 1,
wherein the supplying unit comprises a refrigerant tube, through which the refrigerant is supplied from the storage unit, the refrigerant tube being configured to discharge the refrigerant into the electrochemical system when a fire occurs in the system, thereby extinguishing the fire.

5. The fire-extinguishing device for an electrochemical system of claim 4,
wherein the refrigerant tube performs heat management of the electrochemical system through heat exchange with the electrochemical system.

6. The fire-extinguishing device for an electrochemical system of claim 4,
wherein the refrigerant tube is composed of a thermally conductive material and a thermo-sensitive tube, the thermo-sensitive tube being configured to rupture and melt when a fire occurs in the electrochemical system.

7. The fire-extinguishing device for an electrochemical system of claim 1,
wherein the electrochemical system is one of a battery, a battery cell, a battery module, a battery pack, a battery rack, a hybrid vehicle, an electric vehicle, an energy storage system (ESS), or a distribution board.

8. The fire-extinguishing device for an electrochemical system of claim 1,
wherein the refrigerant contains at least one of methane-based halogenated carbon compounds of refrigerant Nos. 10 to 59, ethane-based halogenated carbon compounds of refrigerant Nos. 110 to 179, propane-based halogenated carbon compounds of refrigerant Nos. 200. to 299, cyclic butane-based halogenated carbon compounds of refrigerant Nos. 300 to 399, non-azeotropic mixed refrigerants of refrigerant Nos. 400 to 499, azeotropic mixed refrigerants of refrigerant Nos. 500 to 599, hydrocarbons, oxygen compounds, sulfur compounds, and nitrogen compounds of refrigerant Nos. 600 to 699, inorganic compounds of refrigerant Nos. 700 to 799, or unsaturated organic compounds of refrigerant Nos. 1000 to 1999 based on the American Society of Heating, Refrigerating and Air-Conditioning Engineers (ASHRAE) Standard 34.

9. The fire-extinguishing device for an electrochemical system of claim 1,
wherein the refrigerant includes at least one of hydrofluoroolefin refrigerants (HFOs), including R-1234yf, R-1233zd, R-1234ze, R-1224yd, R-1336mzz, EC11, EC21, R-448A, R-455A, R-454A, R-454B, R-515B, R-452A, R-466A, R-450A, EC40, or R-471A;
hydrofluorocarbon refrigerants (HFCs), including R-407A, R-407F, R-410A, R-422D, R-134a, R-507A, R-245fa, R-407C, R-408A, R-404A, R-508B, or R-23; hydrochlorofluorocarbon refrigerants (HCFCs), including R-22, R-409A, R-402A, R-402B, R-123, R-124, R-401A, or R-401B; or fluorinated ketones, such as dodecafluoro-2-methylpentan-3-one.

10. The fire-extinguishing device for an electrochemical system of claim 1, wherein the refrigerant has a saturated evaporation temperature of −10 °C or higher and 60 °C or lower at atmospheric pressure, an electrical conductivity of 0 S/cm, a global warming potential (GWP) of 0 or greater and 2 or less, and an ozone depletion potential (ODP) of 0 or greater and 0.001 or less, and does not fall within a flammable range.

11. The fire-extinguishing device for an electrochemical system of claim 1,
wherein the refrigerant includes nanoparticles in an amount greater than 0 weight % and up to 5 weight % containing at least one of Au, Ag, Cu, Al, CuO, Co, Fe, TiO2, CNT, GO, or fullerene.

12. The fire-extinguishing device for an electrochemical system of claim 1,
wherein the refrigerant contains a surfactant in an amount of greater than 0 weight % and up to 5 weight % including at least one of CTAB and Span-80.

13. A heat pump system comprising:
a flash tank configured to store a refrigerant in a gaseous or liquid state;
a compressor configured to compress the refrigerant so that the refrigerant has high temperature and high pressure;
a first heat exchanger configured to exchange heat between the refrigerant and an external environment and to function as an evaporator for heat absorption or a condenser for heat dissipation;
a second heat exchanger configured to perform functions opposite to those of the first heat exchanger and to function as an evaporator or a condenser;
a first expansion valve connected to the flash tank and configured to supply low-temperature and low-pressure refrigerant;
a second expansion valve connected to the flash tank and configured to receive the refrigerant in a liquid state from the flash tank and to bring the refrigerant to a low temperature and a low pressure;
a first four-way valve configured to selectively connect the flash tank, first heat exchanger, second heat exchanger, and first expansion valve to one another;
a second four-way valve configured to selectively connect the compressor, first heat exchanger, and second heat exchanger to one another;
a first valve connected in parallel with the first expansion valve;
a second valve connected in parallel with the second expansion valve;
a third valve disposed between the flash tank and the compressor; and
a fourth valve disposed between the flash tank and the second heat exchanger,
wherein the flash tank comprises a device that generates heat through electrical or chemical reactions, the device exchanges heat with refrigerant stored in the flash tank, and, when a fire occurs in the device, the refrigerant stored in the flash tank extinguishes the fire.

14. The heat pump system of claim 13,
wherein the refrigerant has a saturated evaporation temperature of −10 °C or higher and 60 °C or lower at atmospheric pressure, an electrical conductivity of 0 S/cm, a global warming potential (GWP) of 0 or greater and 2 or less, an ozone depletion potential (ODP) of 0 or greater and 0.001 or less, and does not fall within a flammable range.

15. (canceled)
